(19) United States
(12) Patent Application Publication
(10) Pub. No.: US 2026/0195412 A1
(43) Pub. Date: Jul. 9, 2026

(54) SYSTEMS AND METHODS OF ENHANCED CLUSTERING BASED ON WORD-BOUND N-GRAMS

(71) Applicant: MASTERCARD INTERNATIONAL INCORPORATED, Purchase, NY (US)

(72) Inventor: Tadeu Augusto FERREIRA, Toronto (CA)

(73) Assignee: MASTERCARD INTERNATIONAL INCORPORATED, Purchase, NY (US)

(21) Appl. No.: 19/012,488

(22) Filed: Jan. 7, 2025

(51) Int. Cl. G06F 18/23211; G06F 16/23

(52) U.S. Cl. CPC G06F 18/23211; G06F 16/23

(57) ABSTRACT

A system may access a dataframe having a plurality of records, each record having a respective string of characters. The system may, for each record, from among the plurality of records: generate a plurality of word-bound N-grams based on the respective string of characters of the record, wherein N is an integer number, generate a feature vector for the record based on the plurality of word-bound N-grams. The system may determine levels of similarity between the plurality of records based on the generated feature vectors. The system may cluster the plurality of records into clusters of records based on the levels of similarity. The system may restructure the dataframe to generate a restructured dataframe based on the clusters.

### BACKGROUND

Clustering is a computational technique that groups similar data records together. Similarity is measured based on characteristics of the data records. For data records that include strings of characters, clustering may be performed based on string or character similarity. Clustering may be used in various computational tasks such as Natural Language Processing (“NLP”), machine learning, and similarity detection. Similarity detection is applicable to a wide range of computer functions such as solving clustering problems, which can be used in sentiment analysis, recommendation engines, and anomaly detection, among others.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a computer system for joining data structures based on compound similarity between respective data records of the data structures;

FIG. 2 illustrates an example of word-bound N-grams compared to non-bound N-grams;

FIG. 3 illustrates an example of a method for generating word-bound N-grams;

FIG. 4 illustrates an example of another method for generating word-bound N-grams;

FIG. 5 illustrates an example of a method for restructuring a dataframe for similarity detection using enhanced clustering based on feature vectors generated from word-bound N-grams; and

FIG. 6 illustrates an example of a computer system that may be implemented by devices illustrated in FIG. 1.

### DETAILED DESCRIPTION

The disclosure relates to systems and methods of enhanced clustering based on word-bound N-grams. An N-gram is a sequence of N characters of text in which N is an integer. N-grams may be used as features in clustering. However, generating and using N-grams can be problematic. For example, N-grams can overfit data, which may be problematic when clustering variant data. In particular, spelling variants, misspellings, different ordering of words, and the like may cause features generated from N-grams to overfit specific variants and fail to detect similarity across other variants. Furthermore, when N-grams cross over words, they can create noise especially when it is important to detect string similarity without respect to the order of words in a sequence. This is because an N-gram that spans more than one word links the spanned words together, which can be extra noise that can be detrimental to clustering. Furthermore, N-grams can result in high dimensional feature matrices that can become computationally expensive to process.

Disclosed are improved systems and methods that may mitigate these and/or other issues. In some examples, a system may use word-bound N-grams to generate feature vectors for enhanced clustering of data in a dataframe. Word-bound N-grams may mitigate overfitting and noise by being bounded by words. The high dimensionality of N-grams may be solved by the reduced number of word-bound N-grams compared to other N-grams and may be processed in a sparse matrix environment to improve compactness of the matrices being compared for similarity and clustering.

The system may use the generated word-bound N-grams to generate feature vectors. Each feature vector may correspond to a record, such as a string, for which the word-bound N-grams were generated. Each dimension in the feature vector may correspond to a respective word-bound N-gram, whose value is based on a Term Frequency Inverse Document Frequency value generated for the word-bound N-gram.

The feature vectors may be processed in a sparse matrix environment based on a threshold value. Entries in the feature vectors falling below this threshold may be converted to zero, thereby increasing the compactness and sparseness of the matrix, reducing computational complexity. The system may determine similarity between records in the dataframe based on a comparison of the corresponding feature vectors generated for the records. Based on the similarity, the system may cluster records whose feature vectors have a level of similarity above a similarity threshold. The system may refine the clusters based on an independent string similarity metric to further enhance cluster accuracy. The system may then restructure the dataframe based on the clusters and/or refined clusters. The restructured dataframe may improve similarity detection among data stored in dataframes. The restructured dataframe may be suitable for detecting similarity (or dissimilarity) between records in the dataframe, which may be used for solving clustering problems, performing sentiment analysis, identifying relevant content by recommendation engines, and detecting anomalies, among other implementations.

Having described a high-level overview of various system functions, attention will now turn to an example of a system environment for enhanced clustering based on word-bound N-grams, including a computer system that uses a string similarity model for detecting similarity among data such as strings.

The computer environment 100 may include a computer system 110. The computer system 110 may include one or more computing devices that perform enhanced clustering based on word-bound N-grams. The one or more computing devices of the computer system 110 may each include a processor 112, a memory 114, a data preparation subsystem 120, a feature generation subsystem 130, a fast pre-filtering subsystem 140, a match refinement subsystem 150, and/or other components. The processor 112 may be a semiconductor-based microprocessor, a central processing unit (CPU), an application specific integrated circuit (ASIC), a field-programmable gate array (FPGA), and/or other suitable hardware device. Although the computer system 110 has been depicted as including a single processor 112, it should be understood that the computer system 110 may include multiple processors, multiple cores, or the like. The memory 114 may be an electronic, magnetic, optical, or other physical storage device that includes or stores executable instructions. The memory 114 may be, for example, Random Access memory (RAM), an Electrically Erasable Programmable Read-Only Memory (EEPROM), a storage device, an optical disc, and the like. The memory 114 may be a non-transitory machine-readable storage medium, where the term “non-transitory” does not encompass transitory propagating signals.

The computer system 110 may access an input dataframe 101. A dataframe 101 is a data structure that stores data having one or more strings of characters. In some examples, each dataframe 101 may include rows of data organized into columns. An example of a dataframe 101 is shown in Table 1 for illustration. The computer system 110 may generate word-bound N-grams on one or more data records from dataframe 101. For example, the computer system 110 may generate word-bound N-grams for each of the “merchant_name” string, “address string”, “email” string, and/or other data in the dataframe 101. The system may then generate clusters based on the word-bound N-grams and restructure the data records into a restructured dataframe 103 based on the generated clusters. For example, the restructured dataframe 103 may reorganize the rows in the data structure based on clusters of “merchant_name” deemed to be similar to one another. Table 2 below shows an example of the restructured dataframe 103.

TABLE 1
Example of a dataframe 101.

| Id | merchant_name | address |
|---|---|---|
| cd5d2ea7- | Weber, Murray and Steuber | 524 Grayhawk |
| f7abe2816ae1- | Centide | Lyons |
| 2b42-aacd | | |
| 98a6-42bb- | Boehm and Sons Meemm | 910 Trail Lane |
| 4ea6- | | |
| 8d95ceee0d78 | | |
| 52659402- | Koepp-Okuneva Youbridg | 839 Mendota Circle |
| ad78-99db- | | |
| f7af59dbe276 | | |
| 7df2bcc6- | Blick-Heidenreich Ya | 26 Crossing Trail |
| 19a0adb5e9ae- | | |
| 9243-b5cc | | |
| 5ff17232- | Brightbe Reynolds-Parisian | 912 Crossing |
| 642e036fce99- | | Aberg Alley |
| 45a0-9797 | | |
| 82964996b3fd- | Sipes LLC Devpoi | 884 Pine Butternut |
| a97d-497a- | | |
| 916da5c2 | | |
| ae38-8995- | Oberbrunner, Pfannerstill | 370 Dexter Point |
| 19da-4700 | and Kirlin Thoughtstor | |
| 4f84- | Devbug Auer, Kemmer | 864 Center Avenue |
| da92a4646004- | and Corwin | |
| b000-b667 | | |
| f531b82a-6af8- | Vit Kub LLC | 178 Alley Court |
| bc4b-40ca | | |
| 375e0a39- | Bosco-Smith Blogtags | 44 7th Center |
| 48d7-c637- | | Pleasure |
| 2a4d3b1d | | |
| 89761a82- | Gabcube Yundt Group | 94 Crossing Clove |
| bf63-5285- | | Place |
| e2a0f2ec | | |
| 90a6d3ca0335- | Lehner, Rippin and | 644 Independence |
| 1fff714354af- | Daugherty Realbridg | Drive |
| a54d-4a6b | | |
| 4af0- | Podcat Johnson, Mosciski | 721 Center Pierstorff |
| 4337fd32- | and Jakubowski | Portage |
| 57b0-777b | | |
| 4bd6-906f- | Kerluke-Altenwerth Dabvin | 323 Vale Point |
| 2075- | | |
| 6e74087fb8c7 | | |
| . . . | . . . | . . . |

The data preparation subsystem 120 may preprocess the input dataframe 101 for more efficient and effective feature generation and selection by the feature generation subsystem 130. For example, the data preparation subsystem 120 may remove special and accented characters, stop words, and repeated words. The data preparation subsystem 120 may further convert uppercase letters to lowercase letters. The result of the data preparation subsystem 120 may be a transformed dataframe 101. One example of the transformed dataframe 101 is a data structure generated by the PYTHON Panda library.

The feature generation subsystem 130 may take as input the dataframe 101 transformed by the data preparation subsystem 120 and generate features based on one or more data records from the dataframe 101. The features may include word-bound N-grams. Unlike other N-grams that are not word-bound (“non-bound N-grams”), a word-bound N-gram resets with each new word in a string, thereby excluding N-grams with white spaces or other word delimiter. In other words, the process for generating N-grams is reset at the beginning of each new word, treating each word independently. Thus, a word-bound N-gram does not span more than one word in the string.

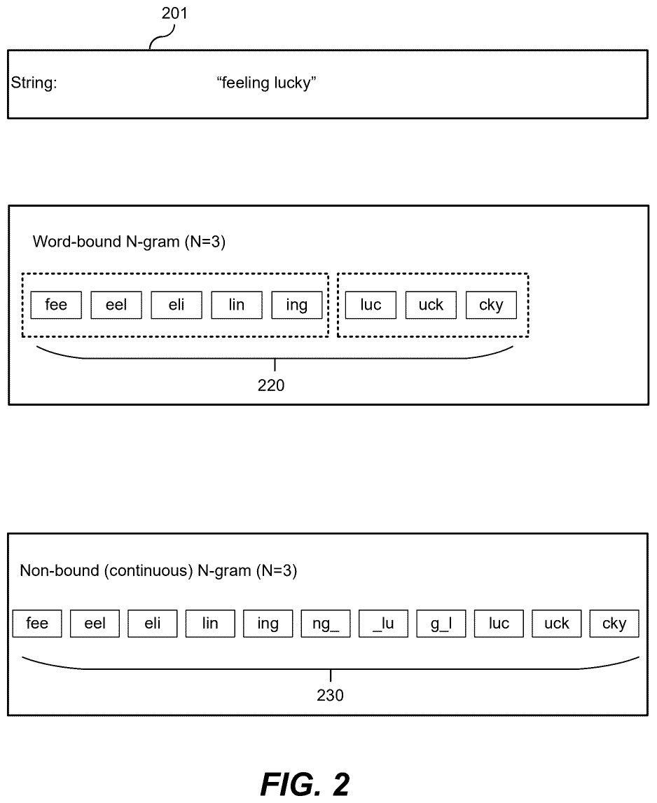

To illustrate, attention will turn to FIG. 2, which illustrates an example of word-bound N-grams 220 compared to non-word-bound N-grams 230. An example of a string 201 (“feeling lucky”) will be described. In FIG. 2, as illustrated, each word-bound N-gram 220 is a trigram in which N=3. However, the feature generation subsystem 130 may be configured to use other N values to generate different length word-bound N-grams 220.

Generating word-bound N-grams 220 and non-word-bound N-grams 230 both involve traversing the string character-by-character to identify groups of N characters in the string. Each group of N characters starts with a character and the following N−1 characters in the string. For example, identifying trigrams in a string involves identifying groups of three characters in which each group includes a character and two subsequent characters that follow the character in the string. However, while word-bound N-grams 220 stop at each word and do not include spaces between words, non-word-bound N-grams 230 do not stop at each word and includes spaces between words. Thus, even in strings with multiple words, none of the word-bound N-grams 220 will span more than one word while non-word-bound N-grams 230 will.

To illustrate, word-bound N-grams 220 and non-word-bound N-grams 230 will be described for the string “feeling lucky” in which N=3. For word-bound N-grams 220, the trigrams are:
“fee” “eel” “eli” “lin” “ing” “luc” “uck” and “cky”
   In this case, the trigrams are formed by considering only the overlapping sequences of three characters, starting from the first character of each word. The process ignores the spaces between the words. Each trigram overlaps with the previous one by two characters, except at the boundary between two adjacent words in the string (such as “feeling” and “lucky”). The process restarts for each word in the string. For example, for each word from among the plurality of words: for each character in the word for which the number of characters remaining in the word, including the character, is equal to or greater than N, generate an N-gram based on the character and the next N−1 characters in the word.

This results in trigrams: ‘fee’, ‘eel’, ‘eli’, ‘lin’, ‘ing’ from “feeling”; and ‘luc’, ‘uck’, ‘cky’ from “lucky”.

For non-word-bound N-grams 230, the trigrams are:
“fee” “eel” “eli” “lin” “ing” “ng” “g_l” “lu” “luc” “uck” and “cky”

In this case, the non-bound trigrams include every sequence of three consecutive characters in the string, including spaces, which are denoted by “_” for clarity. The non-bound trigrams overlap with each other by two characters throughout the entire string, without resetting at word boundaries. Thus, unlike a word-bound N-gram, a given non-bound N-gram can span more than one word.

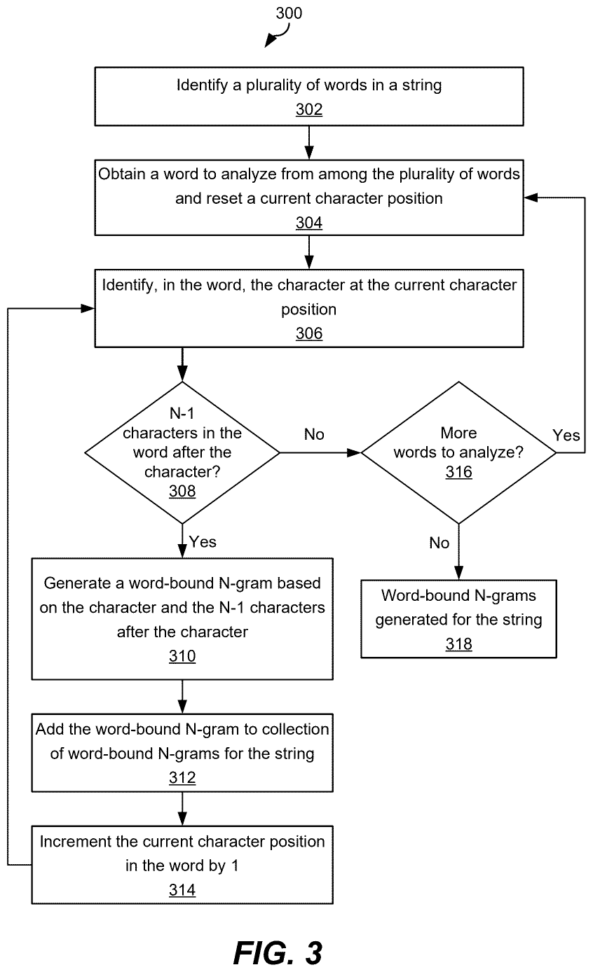

FIG. 3 illustrates an example of a method 300 for generating word-bound N-grams. The method 300 may be executed by the computer system 110 to generate word-bound N-grams for data in a dataframe 101, such as the value of a column in the dataframe 101.

At 302, the method 300 may include identifying a plurality of words in a string. Identifying the plurality of words may include tokenizing the string into component words. Tokenization may involve splitting the string based on a word delimiter such as a white space or other word delimiter. In some examples, identifying the plurality of words may include parsing the string based on a regular expression configured to identify patterns corresponding to words. For example, the words “feeling” and “lucky” may be identified through tokenization. In particular, the words may be identified by splitting the string “feeling lucky” based on a white space that delimits the words.

At 304, the method 300 may include obtaining a word to analyze from among the plurality of words and resetting a current character position. For example, 304-316 may be iterated until word-bound N-grams have been generated for each of the plurality of words. The current character position indicates the starting position of a candidate word-bound N-gram to be generated.

At 306, the method 300 may include identifying, in the word, the character at the current character position. For example, if the current character position is “1” then the character “f” may be obtained for the word “feeling”. If the current character position is “2” then the character “e” may be obtained for the word “feeling”.

At 308, the method 300 may include determining whether there exist N−1 characters in the word after the character. For example, if the current character position is “1” and N=3, then this test will return positive (“yes”) because there exists two characters “ee” after “f” in the word “feeling.”

If the result of 308 is “yes”, then at 310, the method 300 may include generating a word-bound N-gram based on the character and the N−1 characters after the character. For example, for the current character position=1, then word-bound N-gram will be “fee” for the word “feeling”. If the current character position=2, then the word-bound N-gram will be “eel”.

At 312, the method 300 may include adding the word-bound N-gram to collection of word-bound N-grams for the string. For example, the word-bound N-gram may be stored in a memory cache that stores a collection of word-bound N-grams that were generated from the string.

At 314, the method 300 may include incrementing the current character position in the word by 1. For example, if the current character position is 1, the current character position will be incremented to 2. The method 300 may then iterate back to 306.

Returning to 308, if the result of 308 is “no,” then at 316, the method 300 may include determining whether there are more words to analyze. A “no” result at 308 indicates that all word-bound N-grams have been generated for the word. If there are more words to analyze, then the method 300 may iterate back to 304 to analyze the next word in the plurality of words. For example, when word-bound N-grams have been generated for “feeling”, the method 300 may iterate back to 304 to generate word-bound N-grams for “lucky”. Returning to 316, if there are no more words to analyze in the string, then at 318 word-bound N-grams have been generated for the string and processing may exit. The output of the method is a collection of word-bound N-grams that were generated for the string.

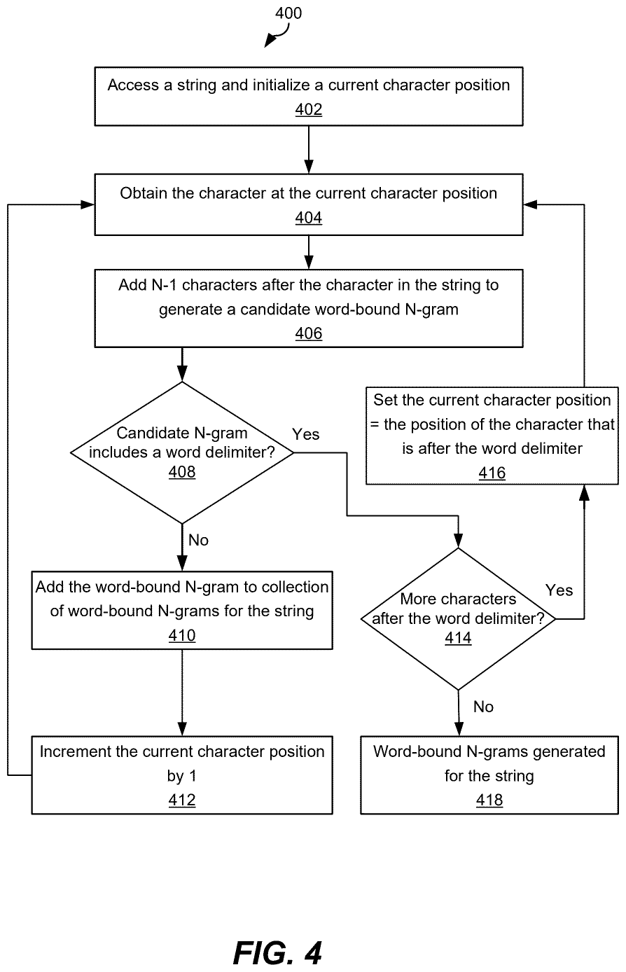

FIG. 4 illustrates an example of another method 400 for generating word-bound N-grams.

At 402, the method 400 may include accessing a string and initializing a current character position. The current character position and corresponding character are similar to those described at FIG. 3. At 404, the method 400 may include obtaining the character at the current character position.

At 406, the method 400 may include adding N−1 characters after the character in the string to generate a candidate word-bound N-gram.

At 408, the method 400 may include determining whether the candidate word-bound N-gram includes a word delimiter, such as a whitespace or other delimiter. If not, then the candidate word-bound N-gram is wholly contained in a current word and the method 400 may proceed to 410. At 410, the method 400 may include adding the candidate word-bound N-gram to the collection of word-bound N-grams for the string. At 412, the method 400 may include incrementing the current character position by 1 and returning to 404.

Returning to 408, if the candidate word-bound N-gram includes a word delimiter, this means that the end of a word in the string has been reached and the method 400 may proceed to 414. At 414, the method 400 may include determining whether there are more characters after the word delimiter. If so, this means there are more words in the string, and the method 400 may proceed to 416. At 416, the method 400 may include setting the current character position=the position of the character that is after the word delimiter, and returning to 404. If there are no more characters after the word delimiter, this means that there are no more words in the string, in which case at 418 word-bound N-grams have been generated for the string and processing may exit. The output of the method is a collection of word-bound N-grams that were generated for the string.

### Feature Vectors for Clustering

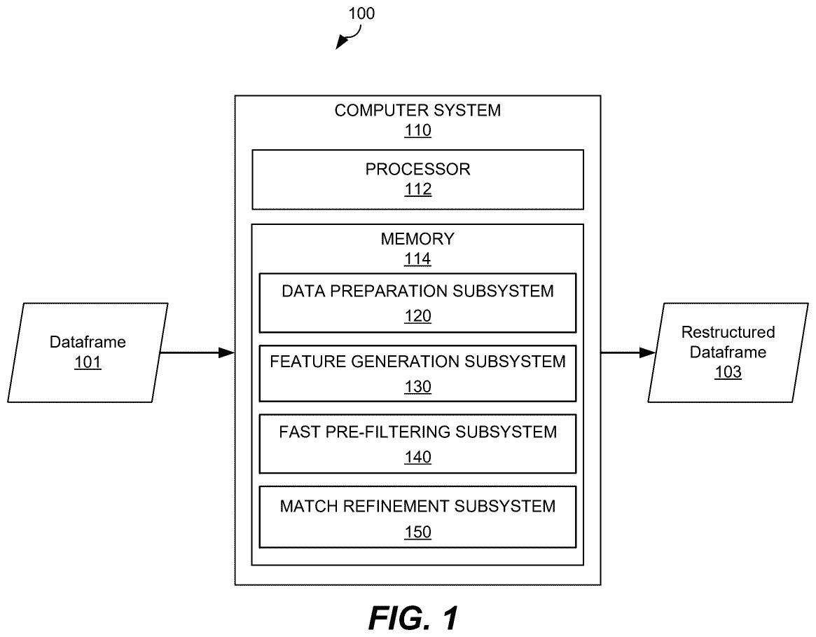

Returning to FIG. 1, the feature generation subsystem 130 may generate feature vectors for the input dataframe 101. Each feature vector will represent a corresponding string for which word-bound N-grams were generated. For example, the feature generation subsystem 130 may vectorize each set of word-bound N-grams. In particular, the feature generation subsystem 130 may generate, for each set of word-bound N-grams generated from a string, a corresponding vector. Each dimension of the vector will correspond to a respective word-bound N-gram. In this example, the number of dimensions is based on the number of word-bound N-grams generated from the string. The value of each dimension of a given vector may be based on a relative importance or frequency of occurrence of the corresponding word-bound N-gram. In some examples, the value of each dimension is based on Term Frequency Inverse Document Frequency (“TF-IDF”) of the respective word-bound N-gram. Generally, TF-IDF is a numerical statistic that reflects the importance of a word in a document in a collection or corpus representing each string as vectors in a high-dimensional space. In this representation, each dimension corresponds to a specific word in the corpus vocabulary

The fast pre-filtering subsystem 140 may reduce the search space for clustering and similarity detection, improving the efficiency and speed of language processing systems. Each record in the dataset is transformed into a TF-IDF vector, where each dimension corresponds to a term's relative importance in a string, considering its frequency in the corpus of string and its rarity across the entire corpus.

The fast pre-filtering subsystem 140 may determine the similarity between feature vectors such via cosine similarity. Cosine similarity measures the cosine of the angle between two vectors in the high-dimensional space created by the TF-IDF process. Cosine similarity is particularly well-suited for this task because it is less affected by the length of the documents and focuses more on the orientation (or the direction) of the vectors, thereby capturing the likeness in terms of content regardless of document size. It should be noted that the fast pre-filtering subsystem 140 may use other vector similarity metrics such as Euclidean distance, Jaccard similarity, Minkowski distance, and Manhattan distance.

To enhance computational efficiency, particularly with large-scale text data of dataframes such as dataframe 101, the fast pre-filtering subsystem 140 may execute within a sparse matrix environment. Sparse matrices represent data by exclusively storing non-zero elements, significantly reducing memory usage and accelerating calculations. This proves especially advantageous in TF-IDF vector representations, where a high number of elements may be zero due to the absence of most words in any given document. In some examples, the fast pre-filtering subsystem 140 may apply a minimum cut-off threshold. Entries falling below this threshold are converted to zero, thereby increasing the compactness and sparseness of the matrix. The threshold may be predefined and/or may be adjusted according to particular needs.

The resulting outcome is a sparse matrix in which row i and column j contain the vector similarity (such as Cosine similarity) applied to the i^{th} and j^{th} feature vectors. These, in turn, correspond to the i^{th} and j^{th} records (such as strings) in the original dataframe 101. Upon obtaining the sparse matrix, the fast pre-filtering subsystem 140 may construct a dataframe that encompasses only the i^{th} and j^{th} records meeting a minimum alpha threshold for similarity. This alpha threshold similarity may be predefined and/or adjusted based on observations of the accuracy of clustering. For each i^{th} row (which corresponds to the i^{th} record in the original dataframe 101), m columns (or records) are identified, each exhibiting a similarity greater than the alpha cosine similarity threshold. Within this group of m columns, the i^{th} column is identified as an exact match to the i^{th} row, indicating a precise correlation. By conducting prefiltering in this optimized environment, the fast pre-filtering subsystem 140 may quickly and efficiently process vast amounts of textual data to identify potential clusters or groups of records that are similar to each other.

The match refinement subsystem 150 may refine the identified potential clusters based on an independent similarity score. An example of a similarity score that can be used is a compound similarity score and/or its sub-scores described in U.S. patent application Ser. No. 18/071,294 filed on Nov. 29, 2022, entitled SYSTEMS AND METHODS OF JOINING DATA RECORDS AND DETECTING STRING SIMILARITY, which is incorporated by reference in its entirety herein for all purposes.

The match refinement subsystem 150 may generate a string similarity score that indicates a level of confidence that two input strings (or other data types having segments) are similar to one another. For purposes of illustration, the string similarity score may be a value between 0 and 1, in which 0 indicates no confidence in similarity of the strings to one another and 1 is the highest confidence in similarity. Other scoring scales may be used. A string processed by the match refinement subsystem 150 may refer to a sequence of characters such as text, numbers, symbols, and/or other characters. A string may include one or more segments. A segment may refer to a portion of a string that is discrete from other portions. For example, a segment may include a word in a string. In another example, a segment may be a number that indicates an identifier.

Segments may be delineated from one another by one or more segment separators in the string. Typically, but not necessarily, a segment separator is whitespace. Other types of segment separators may be used, depending on the input strings being processed. In some examples, the match refinement subsystem 150 may parameterize the segment separator. For example, the match refinement subsystem 150 may receive, as an input parameter, a segment separator for processing an input string. Thus, strings with unique or otherwise specific segment separators, such as a “*”, “|”, and/or other specific characters, may be segmented into segments in a customized way. The match refinement subsystem 150 may use a default segment separator (such as whitespace) and/or a parameter segment separator that specifies a specific segment separator to be used for one or both of the input strings being evaluated for similarity (hereinafter, “candidate strings”).

A given segment may be abbreviated, contain errors such as misspellings, have a unique order with respect to other segments in a string, and/or have other variations depending on the source of the string. For example, a dataframe 101 may store an address as a first string in which with a building number is followed by a street name (such as “123 Main Street”) while a restructured dataframe 103 stores an address as a second string in which the building number follows the street name (such as “Main Street 123”). In another example, the dataframe 101 may further store an entity name with a transcription error (such as “ABC conpamy” while the restructured dataframe 103 correctly spells the entity name (such as “ABC company”). In still another example, instead of or in addition to errors, the dataframe 101 may store the entity name with an abbreviation, such as “ABC co.” while the dataframe 101 does not. Due to these and other variations in the way strings for various data fields of data records are stored in data structures 101 and 103, it may be difficult to determine whether a first data record from the dataframe 101 refers to the same entity as a second data record from the restructured dataframe 103.

The match refinement subsystem 150 may generate the sequence similarity score in a way that tolerates variation in ordering and sentence structure, misspellings, abbreviations and/or other variations between candidate strings. The match refinement subsystem 150 may do so based on an intersection, near-intersection, and non-intersection of the candidate strings. Alternatively, or additionally, the match refinement subsystem 150 may normalize the variations based on a cardinality of the string elements in the strings that differ from one another, thereby smoothing out relatively minor errors compared to the number or size of the string elements. In some examples, the match refinement subsystem 150 may include a dictionary that maps terminology. For example, the dictionary may include a mapping between “Co.” and “Company” so that these terms will match. Other mapped terminologies may be used as well such as “and” and “&” and so forth.

Operations of the match refinement subsystem 150 will be made with reference to a first string (“123 Main Streat Suite 101”) and a second string (“Main Street 123 #101”). The first string includes a building number followed by a street name and office number identified by the word “Suite”. In this example, the first string has a typographical error in the word “street”. The second string includes the street name followed by the building number and suite number designed with a “#” symbol. Computationally, it may be difficult to determine that the first and second strings refer to the same address. For example, using an edit distance metric alone would result in a similarity penalty for the ordering of the building number, the typographical error, and the variation in office number representation.

To mitigate against these and other variations (such as variations in other data fields of the dataframe 101), the match refinement subsystem 150 may identify a plurality of segments for each of the strings. For example, the match refinement subsystem 150 may identify a first plurality of segments (set_a) by splitting the first string using a first segment separator and identify a second plurality of segments (set_b) by splitting the second string using a second segment separator. In this example, the first and second segment separators are each whitespace. However, segment separators other than whitespace may be used instead or in addition to only whitespace. It should be further noted that the first and second segment separators may be the same or different from one another, enabling customization and scalability for data structures that use different segment separators.

It should be noted that the match refinement subsystem 150 may operate on any data that includes “segments.” That is, the match refinement subsystem 150 may take as input a plurality of segments of data and process them as segments. More particularly, in some examples, the match refinement subsystem 150 may not have to split a string into segments. In these examples, the match refinement subsystem 150 may take as input an array or other collection of segments such as words and compare that array to another array of segments, or to a string that has segments.

### Identifying Intersections

The match refinement subsystem 150 may identify an intersection between set_a and set_b. The intersection may include segments that are common to both set_a and set_b. For example, the intersection may include words that have exact matches in both set_a and set_b. In the illustrated example, the intersection includes the segments “123” and “Main” since both of these segments are exactly in the first string (and its set_a) and the second string (and its set_b).

### Identifying Near-Intersections

The match refinement subsystem 150 may compute a first difference set (diff_a_i) between set_a and the intersection and a second difference set (diff_b_i) between set_b and the intersection. Diff_a_i includes segments (if any) that are in set_a but not in the intersection. For example, diff_a_i may define words (and/or other segments) in the first string not found with an exact match to any of the words (and/or other segments) in the second string. In the illustrated example, diff_a_i includes segments “Streat,” “Suite” and “101” because these segments are not in the intersection. Diff_b_i includes segments (if any) that are in set_b but not in the intersection. For example, diff_b_i defines the set of words (and/or other segments) in the second string not found with an exact match to any of the words (and/or other segments) of the first string. In the illustrated example, diff_b_i includes segments “Street” and “#101” because these segments do not appear in the intersection.

The match refinement subsystem 150 may identify a near-intersection between diff_a_i and diff_b_i. The near-intersection defines segments (if any) in diff_a_i that are similar to segments in diff_b_i. For example, the near-intersection may include words (and/or other segments) in diff_a_i that are similar to diff_b_i. Thus, the near-intersection may define segments in the first string that are similar to but do not exactly match other segments in the second string. This may occur when words or other segments in the first string or the second string are misspelled, abbreviated (if not in the dictionary), or otherwise may refer to the same word in one string but has some variation in the other string.

To generate the near-intersection, the match refinement subsystem 150 may perform segment similarity comparisons of all unique pairs of segments in diff_a_i and diff_b_i. For example, the match refinement subsystem 150 may identify the smaller of diff_a_i and diff_b_i in terms of number of segments each have. In this example, diff_b_i has the smaller number of segments. The match refinement subsystem 150 may perform a segment similarity comparison between each segment in diff_b_i with each segment in diff_a_i. For example, the match refinement subsystem 150 may determine a segment similarity between each of pairs: “Street”-“Streat”; “Street”−“Suite”; and “Street”−“101”. Likewise, the match refinement subsystem 150 may determine a segment similarity between each of pairs: “#101”−“Streat”; “#101”−“Suite”; and “#101”−“101”.

### Segment Similarity

To perform segment similarity for inclusion as part of a near-intersection, the match refinement subsystem 150 may use an edit distance that takes into account the length of each segment being compared. For example, the match refinement subsystem 150 may determine the segment similarity between compared segments based on Equation (1) below:

$${S}_{s egment} = 1 - \frac{dist ( segment\_a , segment\_b )}{max ( len ( {segment}_{a} ) , len ( {segment}_{b} ) )} , \qquad ( 1 )$$

in which:
S_{segment}=segment similarity score indicating similarity of segment_a and segment_b;
dist(segment_a, segment_b)=a distance metric indicating a difference between segment_a and segment_b; and
max(len (segment_a), len(segment_b))=the larger length among the lengths of segment_a and segment_b.

The segment similarity score may represent a level of similarity between a pair of segments (segment_a and segment_b) based on a distance metric and length of the larger of the two segments. The distance metric may be an edit distance that measures a number of changes that needs to be made to one segment (such as segment_a) to match the other segment (such as segment_b). Thus, less similar segments will result in a larger distance between the segments. In some examples, the edit distance may be a Levenshtein distance, a hamming distance, a Jaro-Winkler distance, and/or other edit distance. The match refinement subsystem 150 may use other types of similarity models for the distance metric. For example, the match refinement subsystem 150 may use a sequence-based similarity model that assesses similarity based on matching substrings between the segments.

In the example of Equation (1), a larger distance (difference) between the segments results in a lower segment similarity score. The effect of the distance may be moderated by the largest length of the segments being compared. Thus, differences between segments will have less impact on the segment similarity score as segment length increases. A segment similarity score of 0 indicates there is no similarity between the segments while a segment similarity score of 1 indicates the segments are identical.

The match refinement subsystem 150 may compare the segment similarity score to a segment similarity threshold value to determine whether the segments should be considered part of the near-intersection. For example, if the segment similarity score meets or exceeds the segment similarity threshold value, the match refinement subsystem 150 may increment a counter that counts the number of segments in the near-intersection. In some examples, only highest scoring segment similarity scores for a given segment in the diff_a_i or diff_b_i being compared that exceeds the segment similarity threshold value may be added to the near-intersection. This may avoid double-counting if, for example, a given segment in diff_a_i has multiple similarity matches in diff_b_i. In other examples, all matches that exceed the segment similarity threshold value may be added to the near-intersection.

The segment similarity threshold value may be predefined by a developer and/or may be learned from prior observations of segments that have been included in the near-intersection. It should be noted that the segment similarity threshold value may be specific for each data field. For example, an address may be associated with one segment similarity threshold value, while an entity name may be associated with another segment similarity threshold value.

### Identifying Non-Intersections

The match refinement subsystem 150 may identify a non-intersection between set_a and set_b. The non-intersection defines segments in set_a and set_b that are not in the intersection and not in the near-intersection. For example, the non-intersection may include words (if any) and/or other segments that are not exact matches and not above a segment similarity threshold value between set_a and set_b. In the foregoing example, the non-intersection includes the word “Suite” because this word from set_a is not in the set_b and is not similar to other words in set_b. In set_b, all words are either in set_a or are similar to set_a beyond the segment similarity threshold value.

String similarity based on the intersection, near-intersection, and non-intersection

The match refinement subsystem 150 may generate a string similarity score based on the intersection, near-intersection, and non-intersection. In some examples, the match refinement subsystem 150 may perform a preliminary test to the string similarity score. For example, the preliminary test may be given by Equation (2):

$${S}_{string} = 0 if {K}^{2} < {J}^{2} . , \qquad ( 2 )$$

In which:
K=the sum of the number of segments in the intersection and the number of segments in the near-intersection, and
J=the number of segments in the non-intersection.

As illustrated in Equation (2), the match refinement subsystem 150 may set the string similarity score to zero (indicating no similarity) if the sum of the number of segments in the intersection and the number of segments in the near-intersection is less than the number of segments in the non-intersection. It should be noted that a weighting value may be added to K² or J². It should be noted that a value may be added to either K² or J² in Equation (2) to adjust the threshold at which the string similarity score is set to zero. As illustrated, the value is zero.

If the sum of the number of segments in the intersection and the number of segments in the near-intersection is greater than the number of segments in the non-intersection, then the match refinement subsystem 150 may generate the string similarity score according to Equation (3):

$${S}_{string} = \frac{{K}^{2} - {J}^{2}}{L} , \qquad ( 3 )$$

in which:
K=the sum of the number of segments in the intersection and the number of segments in the near-intersection,
J=the number of segments in the non-intersection, and
L=a modifier that adjusts the similarity score based on a difference in cardinality of diff_a_i and diff_b_i and a parameter to control the penalty imposed by the difference in cardinality.

Equation (4) show an example of determining the modifier (L):

$$L = \frac{( {K}^{2} - {J}^{2} ) + abs ( \vert diff\_a \_i \vert - \vert diff\_b \_i \vert )}{S L} , \qquad ( 4 )$$

in which:
K=the sum of the number of segments in the intersection and the number of segments in the near-intersection,
J=the number of segments in the non-intersection,
   |diff_a_i|=the cardinality of diff_a_i,
   |diff_b_i|=the cardinality of diff_b_i, and
SL=the parameter to control the penalty imposed by differences in cardinality.

If there is a large difference in cardinality between diff_a_i and diff_b_i, then the modifier (L) will tend to be larger, making the string similarity score (S_{string}) smaller. This is because larger differences in the cardinality may indicate that one of the two candidate strings have many more non-matching segments compared to the other candidate string, making the candidate strings less likely to be similar to one another. Thus, differences in cardinality may impose a penalty on the string similarity score. In some examples, to moderate this penalty effect, the SL may be adjusted as needed. For example, the SL parameter may be set to a default value and/or may be adjusted for specific datasets.

By using the intersection, near-intersection, and non-intersection, the match refinement subsystem 150 may determine similarity of a first candidate string 402 and a second candidate string 404 without respect to variations in segment order because the segments are modelled based on arrays or sets of words rather than relying on the order in which those words appear in each candidate string. The match refinement subsystem 150 may also tolerate variations in spelling or abbreviations by applying a segment similarity score at the segment level and also takes into account the length of the longest segment being compared.

The match refinement subsystem 150 may generate a restructured dataframe 103 based on the clustering and refinement using the similarity score. The restructured dataframe 103 is a refined version of the original dataframe 101, retaining its original structure in terms of the number of rows and columns. However, the restructured dataframe 103 includes an enhanced organization in which similar rows, identified as belonging to the same cluster, are strategically positioned adjacent to one another. Additionally, the restructured dataframe 103 may include a new column designated to display the cluster identifier. The cluster identifier not only aids in the clear categorization of the data but also significantly streamlines the process of identifying and analyzing related data groups within the dataset.

TABLE 2
Example of a restructured dataframe 103 in which three clusters
are shown: Koepp-Okuneva, Bosco-Smith and Mills-Dooley.

| Cluster | | | |
|---|---|---|---|
| ID | id | merchant_name | address |
| 1 | 52659402- | Koepp-Okuneva Youbridg | 839 Mendota |
| | ad78-99db- | | Circle |
| | f7af59dbe276 | | |
| 1 | c408-9263- | Koepp-Okuneva Inn | 45 Crossing |
| | af6f7ba6-424e | | Springs |
| 1 | aea0- | Omb Koepp-Okuneva | 290 Packers |
| | 92b744de- | | Circle |
| | 29cecb1b-4368 | | |
| 1 | 418f-bdda- | Koepp-Okuneva Sky | 647 Rieder |
| | 5a8d-4c9a | | Melrose Way |
| 1 | 3615262d- | Koepp-Okuneva Oob | 223 Mar Road |
| | 448f-4fbe-0977 | | |
| 1 | e8b7a0954c57- | Tav Koepp-Okuneva | 666 Junction |
| | b54f5134f0e5- | | Hermina |
| | 6d30-88ea | | |
| 1 | b43b-4d22- | Vit Koepp-Okuneva | 451 Prentice |
| | 9f7d- | | Melrose Way |
| | 642e036fce99 | | |
| 2 | 375e0a39- | Bosco-Smith Blogtags | 44 7th Center |
| | 48d7-c637- | | Pleasure |
| | 2a4d3b1d | | |
| 2 | 983e- | Bosco-Smith Inn | 977 Court |
| | b79973c9ef28- | | Roth Shasta |
| | 813d5d51-2bbb | | |
| 2 | 7245699e5bdc- | Jaz Bosco-Smith | 126 Packers |
| | 32b4db05718e- | | Pass Hayes |
| | 48ad-ac6f | | |
| 3 | aab2- | Mills-Dooley Wiki | 881 Cross |
| | 5cec6544e8ff- | | Crest |
| | fa03c6ff-9e1e | | |
| 3 | b333-9ca0- | Mills-Dooley Wikivu | 26 Hill |
| | 550d6a3e63ab- | | International |
| | bb2d | | |
| 3 | 8961-d283- | Mills-Dooley Min | 955 Union |
| | 8f0476793920- | | Lukken Road |
| | 6d0d | | |
| 3 | e4711af4d4fd- | Mills-Dooley Gev | 875 Farragut |
| | c7f92b0e- | | Parkway |
| | 6eaa3a93383e- | | Bayside Parkway |
| | b048 | | |
| 3 | 30895d996149- | Om Mills-Dooley | 360 Road Court |
| | 66f3-42db- | | |
| | 99c6 | | |

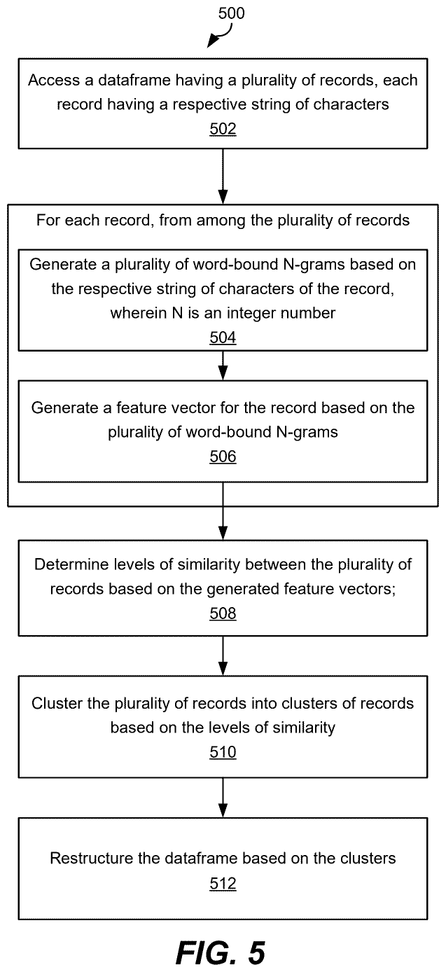

FIG. 5 illustrates an example of a method 500 for restructuring a dataframe for similarity detection using enhanced clustering based on feature vectors generated from word-bound N-grams. At 502, the method 500 may include accessing a dataframe (such as dataframe 101) having a plurality of records, each record having a respective string of characters. For each record, from among the plurality of records, the method 500 may execute 504 and 506. At 504, the method 500 may include generating a plurality of word-bound N-grams based on the respective string of characters of the record, wherein N is an integer number. At 506, the method 500 may include generating a feature vector for the record based on the plurality of word-bound N-grams. At 508, the method 500 may include determining levels of similarity between the plurality of records based on the generated feature vectors. At 510, the method 500 may include clustering the plurality of records into clusters of records based on the levels of similarity. At 512, the method 500 may include restructuring the dataframe based on the clusters to generate a restructured dataframe (such as restructured dataframe 103). Restructuring may group similar data records such as rows of the dataframe as determined from similarity detection and clustering.

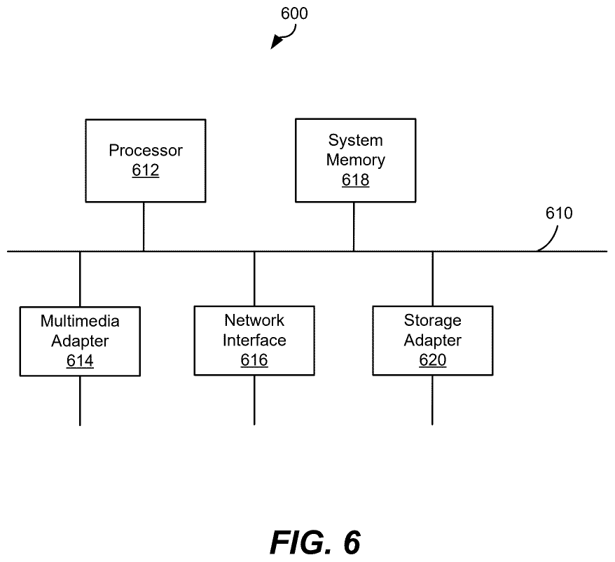

FIG. 6 illustrates an example of a computer system 600 that may be implemented by the computer system 110 illustrated in FIG. 1. For example, the computer system 110 may be implemented based on some or all of the computer system 600. The computer system 600 may include, among other things, an interconnect 610, a processor 612, a multimedia adapter 614, a network interface 616, a system memory 618, and a storage adapter 620.

The interconnect 610 may interconnect various subsystems, elements, and/or components of the computer system 600. As shown, the interconnect 610 may be an abstraction that may represent any one or more separate physical buses, point-to-point connections, or both, connected by appropriate bridges, adapters, or controllers. In some examples, the interconnect 610 may include a system bus, a peripheral component interconnect (PCI) bus or PCI-Express bus, a HyperTransport or industry standard architecture (ISA)) bus, a small computer system interface (SCPI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 610 may allow data communication between the processor 612 and system memory 618, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 612 may control operations of the computer system 600. In some examples, the processor 612 may do so by executing instructions such as software or firmware stored in system memory 618 or other data via the storage adapter 620. In some examples, the processor 612 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 614 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 616 may provide the computer system 600 with an ability to communicate with a variety of remote devices over a network. The network interface 616 may include, for example, an Ethernet adapter, a Fibre Channel adapter, and/or other wired- or wireless-enabled adapter. The network interface 616 may provide a direct or indirect connection from one network element to another and facilitate communication and between various network elements. The storage adapter 620 may connect to a standard computer readable medium for storage and/or retrieval of information, such as a fixed disk drive (internal or external).

Other devices, components, elements, or subsystems (not illustrated) may be connected in a similar manner to the interconnect 610 or via a network. The devices and subsystems can be interconnected in different ways from that shown in FIG. 6. Instructions to implement various examples and implementations described herein may be stored in computer-readable storage media such as one or more of system memory 618 or other storage. Instructions to implement the present disclosure may also be received via one or more interfaces and stored in memory. The operating system provided on computer system 600 may be MS-DOS®, MS-WINDOWS®, OS/2®, OS X®, IOS®, ANDROID®, UNIX®, Linux®, or another operating system.

In operation, the disclosed systems and methods may be used in various contexts. In one example context, the disclosure may be implemented to restructure data in a dataframe 101 to generate a restructured dataframe 103. As a non-limiting example, a payment network may have its own data relating to merchants that accept payments through the payment network. However, the data relating to merchants may be incomplete or inaccurate. The payment network may access third party data relating to entities, including merchants. An example of such third party data may include data from AggData, which provides merchant data that may be unknown or unavailable to the payment network. However, the payment network may be unable to match such third party merchant data with its merchant data. This may be because the payment network merchant and the third party merchant data may be formatted differently (such as examples of address format differences shown in FIGS. 2 and 3), one may include errors in various fields of data, and/or other variations. By using a computer system 110 improved to automatically join data records based on compound similarity, the payment network may be able to match data records from its internal data with data records from third party providers, thereby enriching (adding to) and/or replacing its own data records. It should be further noted that the match refinement subsystem 150 may be used in various contexts other than for joining data records. For example, the match refinement subsystem 150 may be used whenever similarity between strings with multiple segments are useful. In particular, such contexts may include natural language processing, machine translation, recommendation engines, bioinformatic sequences comparisons, and/or others.

In some examples, the word-bound N-grams, corresponding feature vectors, similarity detection, clustering, and/or restructuring described herein may be used to identify and remove duplicate records. In this way, data storage systems such as databases and filesystems may be improved to reduce their storage footprint. In other examples, the word-bound N-grams, corresponding feature vectors, similarity detection, clustering, and/or restructuring described herein may be used for recommendation engines that attempt to detect similarity or dissimilarity among content for recommending content preferences. For example, if a user is known to prefer specific content such as multimedia, audio, products, or services, the similarity, clustering, and/or restructuring described herein may be used to identify similar content based on descriptions or other strings associated with the content. Similarly, recommendation systems may be improved to avoid content that is dissimilar to preferred content. In yet other examples, the word-bound N-grams, corresponding feature vectors, similarity detection, clustering, and/or restructuring described herein may be used for anomaly detection by searching, for example, through log patterns that indicate similarity (or dissimilarity) to known anomalous data such as network intrusion events, device or service failure events, or other anomalous events of interest. Other implementations may be improved based on the

Throughout the disclosure, the terms “a” and “an” may be intended to denote at least one of a particular element. As used herein, the term “includes” means includes but not limited to, the term “including” means including but not limited to. The term “based on” means based at least in part on. In the Figures, the use of the letter “N” to denote plurality in reference symbols is not intended to refer to a particular number. For example, “201A-N” does not refer to a particular number of instances of 201A-N, but rather “two or more.”

The dataframes 101 and 103 may be stored in one or more databases that may, include, or interface to, for example, an Oracle™ relational database sold commercially by Oracle Corporation. Other databases, such as Informix™, DB2 or other data storage, including file-based (such as spreadsheet or extensible markup language documents), or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The systems and processes are not limited to the specific embodiments described herein. In addition, components of each system and each process can be practiced independently and separate from other components and processes described herein. Each component and process also can be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in FIG. 1.

This written description uses examples to disclose the embodiments, including the best mode, and to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a processor programmed to:
access a dataframe having a plurality of records, each record having a respective string of characters;
for each record, from among the plurality of records:
identify individual words from the respective string in the record;
generate a plurality of word-bound N-grams based on the respective string of characters of the record, wherein N is an integer number and wherein a last word-bound N-gram for each word includes the last N characters of the word or less than the last N characters of the word;
generate a feature vector for the record based on the plurality of word-bound N-grams;
determine levels of similarity between the plurality of records based on the feature vectors;
cluster the plurality of records into clusters of records based on the levels of similarity; and
restructure the dataframe into a restructured dataframe based on the clusters of records.

2. The system of claim 1, wherein at least one string of characters includes a plurality of words, and wherein to generate the plurality of word-bound N-grams, the processor is further programmed to:
for each word from among the plurality of words:
for each character in the word for which the number of characters remaining in the word, including the character, is equal to or greater than N, generate a word-bound N-gram based on the character and the next N−1 characters in the word.

3. The system of claim 1, wherein none of the plurality of word-bound N-grams span more than a single word.

4. The system of claim 1, wherein to generate the feature vector, each word-bound N-gram for a corresponding string is represented as a respective dimension in the feature vector for each record.

5. The system of claim 4, wherein the processor is further programmed to:
for each record, determine a frequency of occurrence of each word-bound N-gram, wherein a value for each dimension in the feature vector for the record is based on the determined frequency and is adjusted based on its document frequency.

6. The system of claim 4, wherein to determine levels of similarity between the plurality of records, the processor is further programmed to:
for a given pair of records in the plurality of records, determine a vector similarity between corresponding feature vectors of the given pair of records.

7. The system of claim 2, wherein the feature vectors are processed in a sparse matrix environment that increases compactness and improves efficiency of similarity comparisons between the feature vectors.

8. The system of claim 1, wherein the clusters of records are refined based on a string similarity metric that is based on intersections between pairs of records in the dataframe, near-intersections between the pairs of records in the dataframe, and/or non-intersections between the pairs of records in the dataframe.

9. The system of claim 1, wherein N=3.

10. A method, comprising:
accessing, by a processor, a dataframe having a plurality of records, each record having a respective string of characters;
for each record, from among the plurality of records:
generating, by the processor, a plurality of word-bound N-grams based on the respective string of characters of the record, wherein N is an integer number;
identifying, by the processor, individual words from the respective string in the record;
generating, by the processor, a feature vector for the record based on the plurality of word-bound N-grams and wherein a last word-bound N-gram for each word includes the last N characters of the word or less than the last N characters of the word;
determining, by the processor, levels of similarity between the plurality of records based on the feature vectors;
clustering, by the processor, the plurality of records into clusters of records based on the levels of similarity; and
restructuring, by the processor, the dataframe into a restructured dataframe based on the clusters of records.

11. The method of claim 10, wherein at least one string of characters includes a plurality of words, and wherein to generate the plurality of word-bound N-grams, the processor is further programmed to:
for each word from among the plurality of words:
for each character in the word for which the number of characters remaining in the word, including the character, is equal to or greater than N, generate a word-bound N-gram based on the character and the next N−1 characters in the word.

12. The method of claim 10, wherein none of the plurality of word-bound N-grams span more than a single word.

13. The method of claim 10, wherein when generating the feature vector, each word-bound N-gram for a corresponding string is represented as a respective dimension in the feature vector for each record.

14. The method of claim 13, further comprising:
for each record, determining a frequency of occurrence of each word-bound N-gram, wherein a value for each dimension in the feature vector for the record is based on the determined frequency and is adjusted based on its document frequency.

15. The method of claim 13, wherein determining levels of similarity between the plurality of records comprises:
for a given pair of records in the plurality of records, determining a vector similarity between corresponding feature vectors of the given pair of records.

16. The method of claim 11, further comprising:
processing the feature vectors in a sparse matrix environment that increases compactness and improves efficiency of similarity comparisons between the feature vectors.

17. The method of claim 10, wherein the clusters of records are refined based on a string similarity metric that is based on intersections between pairs of records in the dataframe, near-intersections between the between the pairs of records in the dataframe, and/or non-intersections between the pairs of records in the dataframe.

18. The method of claim 10, wherein N=3.

19. A non-transitory computer readable medium storing instructions that, when executed by a processor, programs the processor to:
identify a plurality of words in a string; and
for each word from among the plurality of words:
for each character in the word for which the number of characters remaining in the word, including the character, is equal to or greater than N, generate a word-bound N-gram based on: (1) the character and the next N−1 characters in the word or (2) the character and the remaining characters in the word if the length of the word is less than N such that a last word-bound N-gram for each word includes the last N characters of the word or less than the last N characters of the word; and
generate a feature vector based on the plurality of word-bound N-grams, wherein each dimension of the feature vector comprises a respective word-bound N-gram and a value of each dimension is a corresponding frequency of the respective word-bound N-gram in the string.

20. The non-transitory computer readable medium of claim 19, wherein the instructions, when executed by the processor, further cause the processor to:
compare the feature vector to a second feature vector associated with a second string and generated based on a second set of word-bound N-grams; and
determine a level of similarity of the string and the second string based on the comparison.
